(19) United States
(12) Patent Application Publication
(10) Pub. No.: US 2018/0159968 A1
(43) Pub. Date: Jun. 7, 2018

(54) ELECTRONIC DEVICE SHELL AND ELECTRONIC DEVICE HAVING THE SAME

(71) Applicant: Beijing Xiaomi Mobile Software Co., Ltd., Beijing (CN)

(72) Inventor: Yangyang CAI, Beijing (CN)

(73) Assignee: Beijing Xiaomi Mobile Software Co., Ltd., Beijing (CN)

(21) Appl. No.: 15/823,857

(22) Filed: Nov. 28, 2017

(30) Foreign Application Priority Data
Dec. 1, 2016 (CN) 201611090975.3

(51) Int. Cl. H04M 1/02; H04B 1/3888

(52) U.S. Cl. CPC H04M 1/0252; H04B 1/3888; H04M 1/026

(57) ABSTRACT

Provided is an electronic device shell and an electronic device including the same. According to one or more embodiments, the shell may include a main body and a connecting part provided on the main body. The electronic device includes a mounting part that is configured to form a fixed connection to the connecting part. The main body is a knitted member. The shell of the electronic device is configured for good flexibility and resilience. In this way, damage and depression of the shell due to a bump during use may be reduced effectively without using a complicated slotting process or occupying space to accommodate a local bulge of the electronic device.

### CROSS REFERENCE TO RELATED APPLICATION

This application claims priority to Chinese Patent Application No. 201611090975.3 filed on Dec. 1, 2016, the entire contents of which are incorporated herein by reference.

### TECHNICAL FIELD

The disclosure relates to the field of electronic technology, and more particularly to an electronic device shell and an electronic device having the same.

### BACKGROUND

A plurality of mature products and/or materials are available for use as a one-piece moulded shell or an outer housing of an electronic device. A shell or housing or cover of an electronic device may be easily scratched, worn, dented or otherwise deformed when the electronic device is subjected to bumps and wear during use, which will affect the cosmetic appearance of the shell and the electronic device significantly. At the same time, a one-piece moulded shell cannot accommodate a local bulge of a main board or non-uniform components, resulting in wasted interior space of the electronic device because the one-piece shell needs to be oversized to accommodate all the components. In addition, for a one-piece moulded shell to accommodate keys and buttons on the electronic device, slots or openings need to be formed in a surface of a shell. The process of forming slots or openings increases the complexity of the process and is more costly.

### SUMMARY

This disclosure provides a shell of an electronic device having excellent flexibility and may reduce damage and dents or wear caused during use.

A shell of an electronic device provided according to an example of the disclosure includes a main body and a connecting part that is provided on the main body. The electronic device includes a mounting part that is configured to form a fixed connection to the connecting part. The main body includes a knitted member.

Further, the connecting part an adhesive surface, and the knitted member is bonded to the adhesive surface of the connecting part. The knitted member matches the shape of the electronic device and connects by means of the connecting part. The knitted member may be directly bonded to the connecting part, which facilitates installation due to a simplified assembly process.

Further, the connecting part is provided with at least one catch. The mounting part is provided with at least one slot for accommodating the at least one catch. The connecting part is snap-fit attached to the electronic device by means of the at least one catch. Therefore, it is easy to mount the shell.

Further, the support is provided with at least one arc-shaped transition surface configured to match at least one corner of the electronic device. The at least one arc-shaped transition surfaces (i.e., rounded corners) makes the electronic device more beautiful and ergonomic to grasp as a whole.

Further, the connecting part is configured as a rigid support provided around a perimeter of the knitted member. The mounting part includes a crimping groove configured to engage the rigid support of the connecting part in a locking manner. The edge of the knitted member is directly fixed to the electronic device by means of the crimping groove so that the connecting structure of the shell and the electronic device becomes simple and reliable.

Further, the electronic device is provided with a raised side key. The knitted member covers the side key and is flexibly abutted on the side key. Since the knitted member covers the side key mounted on the electronic device and is flexible, there is no need to provide a slot on a surface of the shell for the side key top pass through. The electronic device is more beautiful and attractive as a whole because of this.

Further, the electronic device may include a camera. The knitted member is provided with an opening configured to match the shape of the camera so that the camera may be used through the opening.

Further, the edge of the opening is provided with a locking member, and the locking member is configured to lock the edge of the opening. The locking member locks the edge of the opening to prevent the knitted member from being torn or covering the camera.

Further, the locking member is provided with an annular groove. The edge of the opening is accommodated in the annular groove. With the edge of the opening accommodated and locked by the annular groove provided on the locking member, the structure is simple and reliable, and the locking member may shield the edge of the opening so that the shell is more beautiful and cosmetically attractive.

Further, the knitted member is formed by a plurality of interwoven metal wires. Therefore, the knitted member of metal wires is configured for improved flexibility and resilience, which results in improved wear resistance. Further still, the knitted member is formed by a plurality of interwoven non-metallic wires. Therefore, the knotted member may have similar properties to the metal wires and potentially be lighter and more cost effective.

The technical solution provided according to an example of the disclosure may include the following beneficial effects: the elastic knitted shell is capable of effectively avoiding damage and dents in the shell caused by a bumps, impacts, or wear, improved adaptation to the variations of the structural design of the electronic device, and reductions in the manufacturing difficulty of the product and lower production costs.

It is to be understood that both the foregoing general description and the following detailed description are merely exemplary and illustrative and do not limit the disclosure.

### BRIEF DESCRIPTION OF DRAWINGS

The drawings herein are incorporated in and constitute a part of the specification to depict embodiments coinciding with the disclosure and, serve to explain the principles of the disclosure together with the specification.

FIG. 1 illustrates an exploded view of a shell of an electronic device and an electronic device according to an example of the disclosure.

FIG. 2 illustrates an exploded view of a structure of a mobile phone shell according to an example of the disclosure.

FIG. 3A illustrates elevational views of a knitted member of a mobile phone shell when under stress in a first direction according to an example of the disclosure.

FIG. 3B illustrates elevational views of a knitted member of a mobile phone shell when under stress in a second direction according to an example of the disclosure.

FIG. 4 illustrates a perspective view of a rear surface of a mobile phone according to an example of the disclosure.

### DETAILED DESCRIPTION

An exemplary embodiment will be described in detail herein, examples of which are shown in the accompanying drawings. When the following description refers to the accompanying drawings, the same numerals in different drawings denote the same or similar elements unless otherwise indicated. The examples described in the following exemplary embodiment are not representative of all examples coinciding with the present disclosure. In contrast, they are merely examples of devices and methods coinciding with some aspects of the present disclosure as detailed in the appended claims.

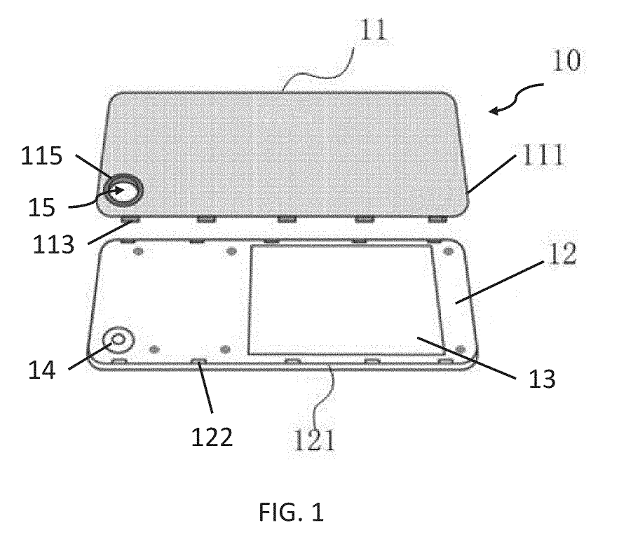

FIG. 1 illustrates an exploded view of a shell of an electronic device and an electronic device according to an example of the disclosure. The shell of an electronic device may also be referred as an electronic device shell. Hereinafter, a technical solution of the disclosure will be described in detail with reference to an example in which a mobile phone is used as an electronic device and a mobile phone shell is used as a shell of an electronic device. As shown in FIG. 1, a shell 10 of an electronic device includes a main body 11 and a support or connecting part 111 provided on the main body 11; the electronic device 12 has a mounting part 121 that matches the shape of and is configured to form a fixed connection to the connecting part 111. The main body 11 includes a knitted member. In some embodiments, the main body 11 is a knitted member. The mounting part 121 may be disposed on an edge of the electronic device.

Since the knitted member 11 has a particular degree of flexibility, use of the knitted member as the shell 10 of the electronic device 12 may reduce cosmetic appearance problems of the electronic device 12 caused by wear and use. Alternatively or additionally, the main body 11 may include other elastic materials such as polymer, rubber, resin, etc.

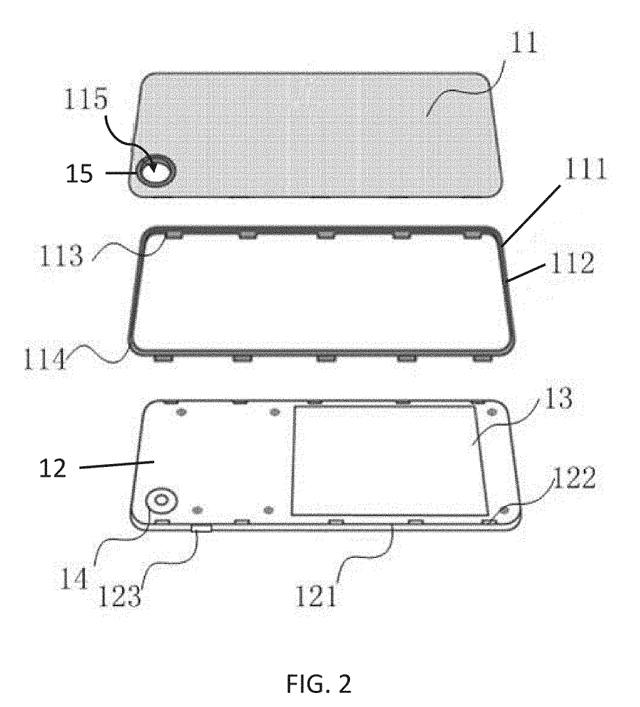

FIG. 2 illustrates an exploded diagram of a structure of a mobile phone shell used as an example of a shell of an electronic device according to an example of the disclosure. As shown in FIG. 2, the electronic device 12 is depicted as a mobile phone. The connecting part 111 is a rigid support having an adhesive surface 112, and the knitted member 11 may be bonded to the adhesive surface 112. The knitted member 11 may be directly bonded to the support and matches the mobile phone 12 through the connecting part 111. Therefore, the mobile phone shell is easy to assemble and the manufacturing process is simple.

As shown in FIG. 2, the connecting part 111 is configured as a frame-shaped support which may not only serve as a connecting member between the knitted member 11 and the mobile phone 12 but also support the knitted member 11. A plurality of catches 113 are provided around the connecting part 111. Correspondingly, a mounting part 121 of the mobile phone 12 is provided with a plurality of slots 122 for accommodating the plurality catches 113. The connecting part 111 may be snap-fit attached to the mobile phone 12 by the plurality of catches 113. Therefore, it is easy to operate during use. At the same time, the plurality of catches 113 and the plurality of slots 122 are provided around the connecting part 111 and the mobile phone 12, respectively, to enhance the fixed connection between the mobile phone shell and the mobile phone.

As shown in FIG. 2, the connecting part 111 is provided with at least one arc-shaped transition surface 114 which matches the rounded shape (i.e., corners) of the mobile phone 12 at the corners of the device. The arc-shaped transition surface 114 makes the mobile phone 12 more beautiful and ergonomic to grip as a whole. It is contemplated that the electronic device 12 and the shell 10 may be any shape besides the rectangle with rounded corners depicted in the present figures.

In one embodiment, the connecting part 111 forms a rigid support provided around a perimeter of the knitted member 11; and the mounting part 121 has a crimping groove which is configured to engage with the rigid support in a locking manner. The edge of the knitted member 11 is directly fixed to the electronic device 12 by means of the crimping groove so that the connecting structure of the shell 10 and the electronic device 12 is simple and reliable.

In another embodiment, the knitted member 11 may also be connected to the mobile phone 12 in other manners such as bonding or welding.

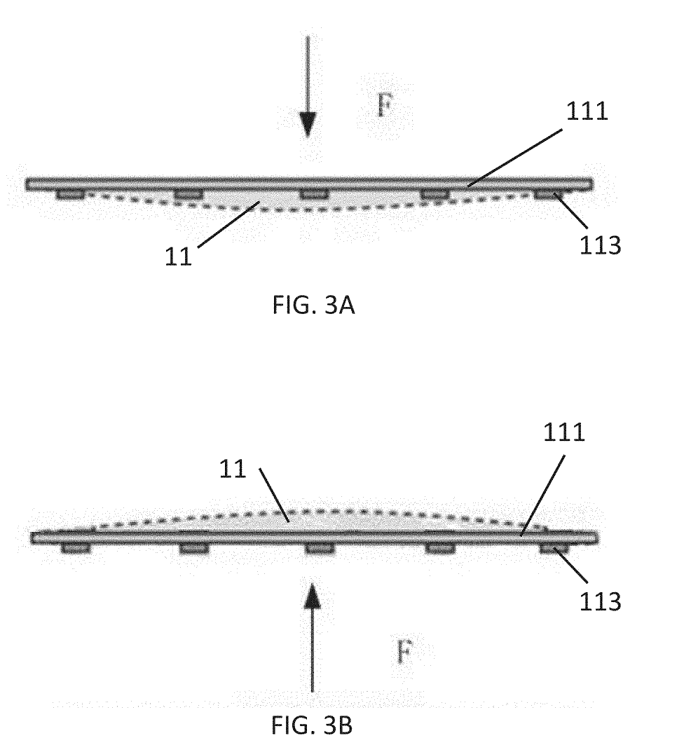

FIGS. 3A and 3B illustrate deformation of a knitted member under a stress according to an example of the disclosure. As depicted in FIG. 3A, the knitted member 11 is configured to flex inwards towards the electronic device 12 when a force F is applied. As depicted in FIG. 3B, the knitted member 11 is configured to flex outwards away from the electronic device 12 when a force F is applied. As shown in FIG. 2, the mobile phone 12 is provided with a raised side key 123. Since the knitted member 11 has a particular degree of flexibility (as shown by FIGS. 3A and 3B), the knitted member 11 may be abutted on or enclosing the side key 123 in a flexible manner when covering the side key 123. There is no need to mount the side key 123 by slotting the mobile phone shell 10 which causes the production process of the mobile phone shell 10 to be simpler, effectively reducing the production cost and the assembling difficulty. At the same time, a corresponding sign or marking may be provided on an outer side of the corresponding portion of the knitted member 11 covering the side key 123 so as to facilitate use by indicating the location of the side key 123 under the knitted member 11.

As shown in FIG. 2, a main board of the mobile phone 12 has a bulge 13. The knitted member 11 is partially and flexibly abutted on the bulge 13 of the main board of the mobile phone when covering the body of the mobile phone 12. Due to the flexibility of the knitted member 11, the portion of the knitted member 11 covering the bulge 13 may be properly stretched without having to make a design to increase the interior space of the mobile phone for the bulge 13. Therefore, the product has a high adaptability.

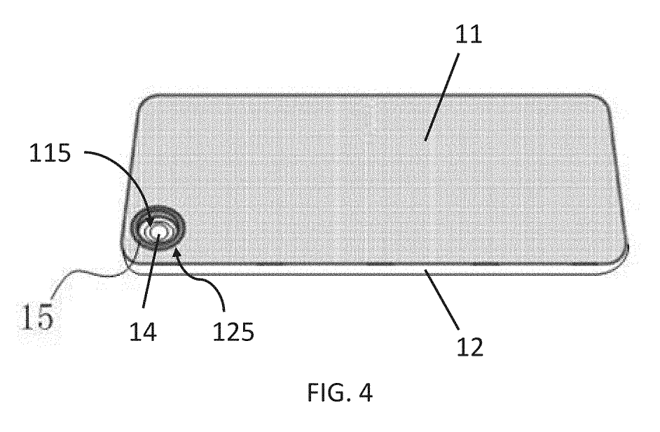

FIG. 4 illustrates a structure schematic diagram of a rear surface of the mobile phone 12. As shown in FIGS. 1, 2, and 4, the knitted member 11 is provided with an opening 115 which is configured to match the shape of the camera 14 of the mobile phone 12. The opening 115 in the knitted member 11 is used to facilitate the use of the camera 14. The edge of the opening 115 is provided with a locking member 15. The locking member 15 is configured to lock the edge of the opening 115 to prevent the knitted member 11 from being torn.

The locking member 15 is provided with an annular groove 125, and the edge of the opening 115 is accommodated and locked in the annular groove 125. With the edge of the opening 115 accommodated and locked by the annular groove 125 provided on the locking member 15, the structure is simple and reliable. At the same time, the locking member 15 also shields the edge of the opening 115 to enhance the overall beauty of the mobile phone shell.

In one embodiment, the edge of the opening 115 may also be locked directly using an edge-locking method of the knitting technique.

In one embodiment, the knitted member 11 may be formed by interweaving a plurality of metal wires. The knitted member 11 made of metal wires provides better flexibility, resilience, and has higher resistance to wear.

In another embodiment, the knitted member 11 may also be formed by interweaving tough non-metallic wires. The material of the non-metallic wires may be elastic fibre, plastic, resin, etc.

In addition, an uneven surface formed on the knitted member 11 in the knitting process may increase the frictional force of the mobile phone shell and play a slip-proof role during use.

Other implementations of the present disclosure will readily occur to those skilled in the art after consideration of the specification and practice of the present disclosure disclosed herein. The present disclosure is intended to cover any variations, uses, or adaptive changes of the present disclosure that follow the general principle of the present disclosure and include the common general knowledge or conventional technical means in the art undisclosed in the present disclosure. The specification and examples are to be merely regarded as exemplary, and the true scope and spirit of the present disclosure are indicated by the following claims.

It is to be understood that the disclosure is not limited to the specific structures described above and shown in the accompanying drawings, and that different modifications and changes may be made without departing from the scope thereof. The scope of the disclosure is limited only by the appended claims.

1. A shell of an electronic device, the shell comprising:
a main body comprising a knitted member; and
a connecting part that is provided on the main body, wherein the electronic device includes a mounting part that is configured to form a fixed connection to the connecting part.

2. The shell according to claim 1, wherein the connecting part includes an adhesive surface, and wherein the knitted member is bonded to the adhesive surface of the connecting part.

3. The shell according to claim 2, wherein the connecting part is provided with at least one catch, and the mounting part is provided with at least one slot for accommodating the at least one catch.

4. The shell according to claim 3, wherein the connecting part is provided with at least one arc-shaped transition surface configured to match at least one corner of the electronic device.

5. The shell according to claim 1, wherein the connecting part is configured as a rigid support provided around a perimeter of the knitted member, and wherein the mounting part includes a crimping groove configured to engage the rigid support of the connecting part in a locking manner.

6. The shell according to claim 1, wherein the electronic device is provided with a raised side key, and wherein the knitted member covers the raised side key and is flexibly abutted on the side key.

7. The shell according to claim 1, wherein the electronic device comprises a camera, and wherein the knitted member is provided with an opening configured to match a shape of the camera.

8. The shell according to claim 7, wherein an edge of the opening is provided with a locking member, and wherein the locking member is configured to lock the edge of the opening.

9. The shell according to claim 8, wherein the locking member is provided with an annular groove, and wherein the edge of the opening is accommodated in the annular groove.

10. The shell according to claim 1, wherein the knitted member comprises a plurality of interwoven metal wires.

11. The shell according to claim 1, wherein the knitted member comprises a plurality of interwoven non-metallic wires.

12. An electronic device, comprising:
a mounting part;
a shell that at least partially encloses a portion of the electronic device, the shell comprising: a main body comprising a knitted member; and a connecting part disposed on the main body,
wherein the mounting part is configured to form a fixed connection to the connecting part.

13. The electronic device according to claim 12, wherein the connecting part includes an adhesive surface, and wherein the knitted member is bonded to the adhesive surface of the connecting part.

14. The electronic device according to claim 13, wherein the connecting part is provided with at least one catch, and the mounting part is provided with at least one slot for accommodating the at least one catch.

15. The electronic device according to claim 14, wherein the connecting part is provided with at least one arc-shaped transition surface configured to match at least one corner of the electronic device.

16. The electronic device according to claim 12, wherein the connecting part is configured as a rigid support provided around a perimeter of the knitted member, and wherein the mounting part includes a crimping groove configured to engage the rigid support of the connecting part in a locking manner.

17. The electronic device according to claim 12, wherein the electronic device is provided with a raised side key, and wherein the knitted member covers the raised side key and is flexibly abutted on the side key.

18. The electronic device according to claim 12, wherein the electronic device comprises a camera, and wherein the knitted member is provided with an opening configured to match a shape of the camera.

19. The electronic device according to claim 18, wherein an edge of the opening is provided with a locking member, and wherein the locking member is configured to lock the edge of the opening.

20. The electronic device according to claim 8, wherein the locking member is provided with an annular groove, and wherein the edge of the opening is accommodated in the annular groove.
